(19) United States
(12) Patent Application Publication
(10) Pub. No.: US 2009/0129094 A1
(43) Pub. Date: May 21, 2009

(54) PRISM SHEET AND BACKLIGHT MODULE USING THE SAME

(75) Inventors: TUNG-MING HSU, Tu-Cheng (TW); SHAO-HAN CHANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/956,352

(22) Filed: Dec. 14, 2007

(30) Foreign Application Priority Data
Nov. 16, 2007 (CN) 200710202571.3

(51) Int. Cl. F21V 7/00; G02B 5/04

(52) U.S. Cl. 362/297; 359/834

(57) ABSTRACT

An exemplary prism sheet includes a transparent main body. The main body includes a first surface, a second surface opposite to the first surface, a plurality of elongated, curved micro-depressions formed in the first surface, and a plurality of elongated, curved micro-protrusions protruding out from the second surface. The micro-depressions extend along first imaginary circular arcs having a same curvature. The micro-protrusions extend along second arcs having a same curvature. A backlight module using the present prism sheet is also provided.

### BACKGROUND OF THE INVENTION

1. Field of the Invention

The present invention relates to prisms, and particularly, to a prism sheet used in a backlight module.

2. Discussion of the Related Art

In a liquid crystal display device (LCD device), liquid crystal is a substance that does not itself illuminate light. Instead, the liquid crystal relies on light received from a light source to display information. In the case of a typical liquid crystal display device, a backlight module powered by electricity supplies the needed light.

FIG. 5 depicts a typical direct type backlight module 100. The backlight module 100 includes a housing 11, a plurality of lamps 12 disposed above a base of the housing 11, and a light diffusion plate 13 and a prism sheet 10 stacked on top of the housing 11 in that order. Inner walls of the housing 11 are configured for reflecting light upwards. The light diffusion plate 13 includes a plurality of dispersion particles (not shown) therein. The dispersion particles are configured for scattering light, thus enhancing the uniformity of light exiting the light diffusion plate 13.

Referring to FIG. 6 together with FIG. 5, the prism sheet 10 includes a base layer 101 and a prism layer 102 formed on the base layer 101. The prism layer 102 contains a plurality of parallel prism lenses 103 having a triangular cross section. The prism lenses 103 are configured for collimating light to a certain extent. Typically, a method of manufacturing the prism sheet 10 includes the following steps: first, a melted ultraviolet (UV)-cured transparent resin is coated on the base layer 101 to form V-shaped lenses, then the melted UV-cured transparent resin is solidified to form the prism lenses 103.

In use, unscattered light from the lamps 12 enters the light diffusion plate 13 and becomes scattered. The scattered light leaves the light diffusion plate 13 and enters the prism sheet 10. The scattered light then travels through the prism sheet 10 before being refracted out at the prism lenses 103 of the prism layer 102. Thus, the refracted light leaving the prism sheet 10 is concentrated at the prism layer 102 and increases the brightness (illumination) of the prism sheet 10. The refracted light then propagates into an LCD panel (not shown) disposed above the prism sheet 10.

When the light is scattered in the light diffusion plate 13, scattered light enters the prism sheet at different angles of incidence. Referring to FIG. 7, when scattered light enters the prism sheet 10 at different angles of incidence, the scattered light generally travels through the prism sheet 10 along three light paths. In the first light path (such as a₁, a₂) the light enters the prism sheet at small angles of incidence and refracts out of the prism lenses with the refracted path closer to the normal to the surface of the base layer. In the second light path (such as a₃, a₄) the light enters the prism sheet 10 at angles of incidence larger than the first light path and refracts out of the prism lenses 103 with the refracted path being closer to the normal to the surface of the prism lenses 103. Both the first light path and the second light path contribute to the brightness of the LED and the light utilization efficiency of the backlight module 100. However, in the case of the third light path (such as a₅, a₆), the light enters the prism sheets at angles greater than the second light path, such that when the refracted light in the third light path leaves the prism sheet 10 at the prism lenses 103 the refracted light impinges on the surface of adjacent prism lens 103 and reenters the prism sheet 10. Thus, light traveling along the third light path will eventually reenter the prism sheet 10 and may exit the prism sheet 10 on the same side the light entered. This third light path does not contribute to the light utilization efficiency of the backlight module 100. Further, the third light path may interfere with or inhibit other incident light resulting in decreasing brightness of the backlight module 100.

What is needed, therefore, is a new prism sheet and a backlight module using the prism sheet that can overcome the above-mentioned shortcomings.

### SUMMARY

In one aspect, a prism sheet according to a preferred embodiment includes a transparent main body. The main body includes a first surface, a second surface opposite to the first surface, a plurality of elongated, curved micro-depressions formed in the first surface, and a plurality of elongated, curved micro-protrusions protruding out from the second surface. The micro-depressions extend along first imaginary circular arcs having a same curvature. The micro-protrusions extend along second arcs having a same curvature.

In another aspect, a backlight module according to a preferred embodiment includes a plurality of lamps, a light diffusion plate and a prism sheet. The light diffusion plate is disposed above the lamps and the prism sheet is stacked on the light diffusion plate. The prism sheet is same as described in a previous paragraph.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present prism sheet and backlight module. Moreover, in the drawings, like reference numerals designate corresponding parts throughout several views, and all the views are schematic.

FIG. 1 is an isometric view of a prism sheet according to a first preferred embodiment of the present invention.

FIG. 2 is a side, cross-sectional view of the prism sheet of FIG. 1, taken along line II-II thereof.

FIG. 3 is similar to FIG. 2, but taken along line III-III of the prism sheet of FIG. 1.

FIG. 4 is a side, cross-sectional view of a backlight module using the prism sheet of FIG. 1 according to a second preferred embodiment of the present invention.

FIG. 5 is a side cross-sectional view of a conventional backlight module employing a typical prism sheet.

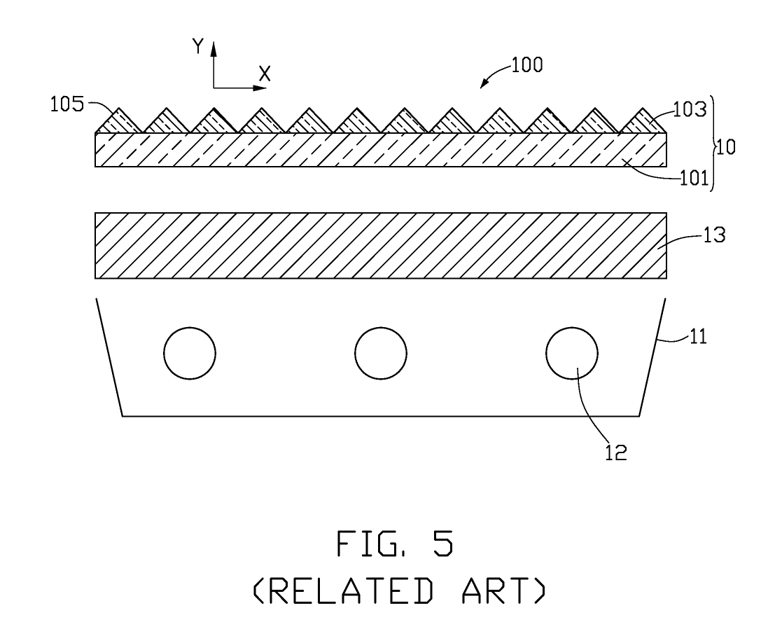

FIG. 6 is an isometric view of the prism sheet shown in FIG. 5.

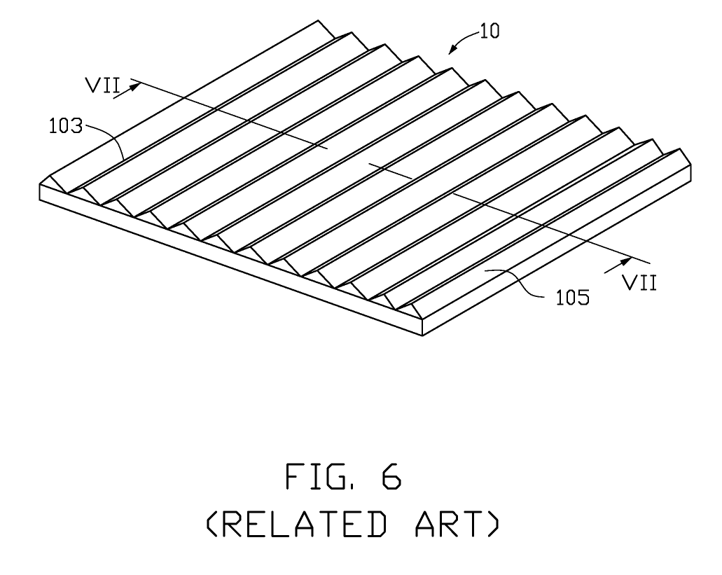

FIG. 7 is side, cross-sectional view of the prism sheet of FIG. 6, taken along line VII-VII, showing light transmission paths.

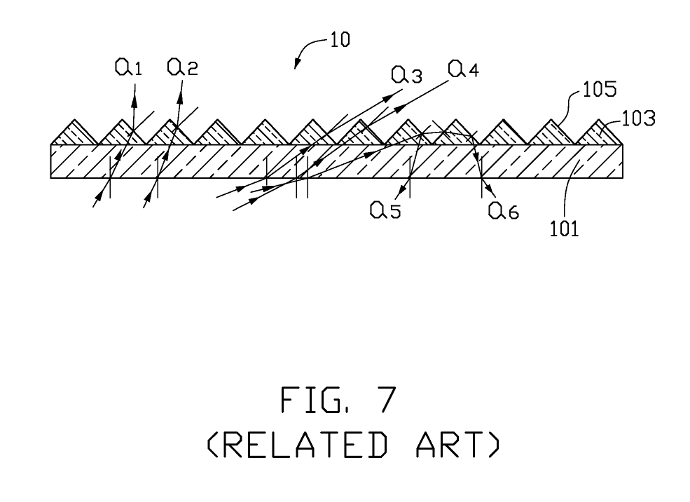

### DETAILED DESCRIPTION OF THE PREFERRED EMBODIMENTS

Reference will now be made to the drawings to describe preferred embodiments of the present prism sheet and backlight module, in detail.

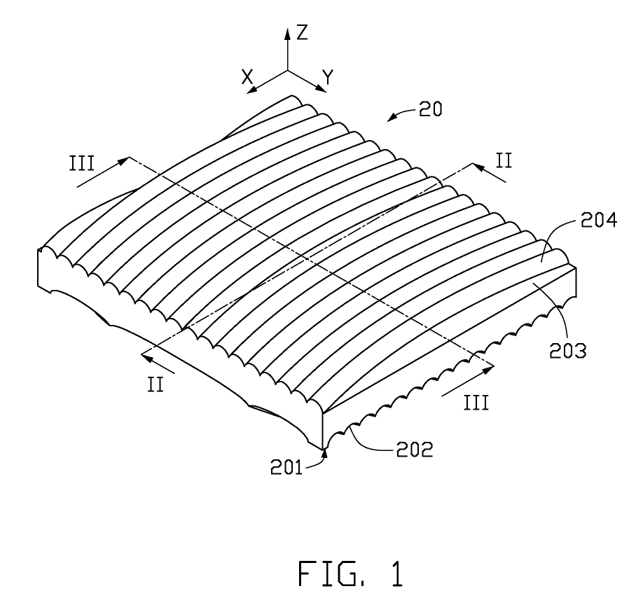

Referring to FIG. 1, a prism sheet 20 in accordance with a first preferred embodiment of the present invention is shown. The prism sheet 20 includes a transparent main body. The main body includes a first surface 201, a second surface 203. The first surface 201 and the second surface 203 are on opposite sides of the main body. The first surface 201 defines a plurality of elongated, curved micro-depressions 202. The micro-depressions 202 extend along first arcs. The micro-depressions 202 have a same curvature. A plurality of elongated, curved micro-protrusions 204 protrude out from the second surface 203. The micro-protrusions 204 extend along second arcs. The micro-protrusions have a same curvature.

In this embodiment, centers of the first arcs are aligned parallely across the line II-II (parallel to a X-axis), and centers of the second arcs are aligned parallely across the line III-III (parallel to a Y-axis). Each of the micro-depressions 202 has a semicircle cross-section taken along the line II-II. Each of the micro-protrusions 204 has a semicircle cross-section taken along line III-III. In other words, a line connecting centers of the first arcs perpendicular to a line connecting centers of the second arcs. In alternative embodiments, the line connecting centers of the first arcs may be oblique with the line connecting centers of the second arcs.

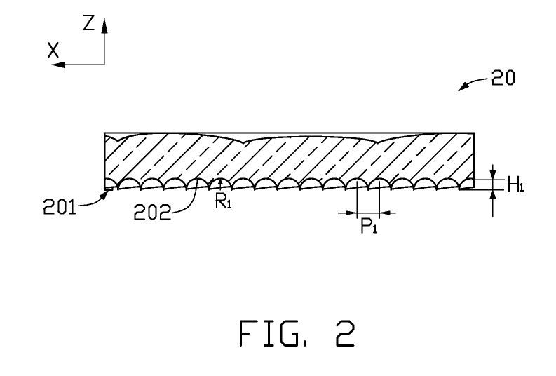

Referring to FIG. 2, a pitch P₁ between adjacent micro-depressions 202 along the X-axis is configured to be in the range from about 0.025 millimeters to about 1.5 millimeters. A radius R₁ of the hemispherical cross-section defined by each of the micro-depression 202 is configured to be in the range satisfying the following expression: P₁/4≦R₁≦2P₁. A depth H₁ of each micro-depression 202 is configured to be in the range satisfying the following expression: 0.01 millimeters≦H₁≦R₁. In this embodiment, the depth H₁ of each micro-depression 202 equals to the radius R₁. The pitch P₁ of adjacent micro-depressions 202 equals to 2R₁.

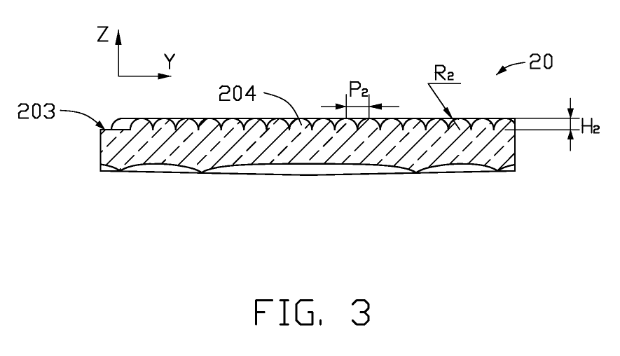

Referring to FIG. 3, a pitch P₂ between adjacent micro-protrusions 204 along the Y-axis is configured to be in the range from about 0.025 millimeters to about 1.5 millimeters. A radius R₂ of the hemispherical cross-section defined by each of the micro-protrusion 204 is configured to be in the range satisfying the following expression: P₂/4≦R₂≦2P₂. A depth H₂ of each micro-protrusion 204 is configured to be in the range satisfying the following expression: 0.01 millimeters≦H₂≦R₂. In this embodiment, the depth H₂ of each micro-protrusion 204 equals to the radius R₂. The pitch P₂ of adjacent micro-protrusions 204 equals to 2R₁.

A thickness of the prism sheet 20 is preferably in the range from about 0.5 millimeters to about 3 millimeters. The prism sheet 20 can be made of transparent material selected from the group consisting of polycarbonate (PC), polymethyl methacrylate (PMMA), polystyrene (PS), copolymer of methylmethacrylate and styrene (MS), and any suitable combination thereof.

Compared with the conventional prism sheet, the prism sheet 20 can be easily mass-produced via the injection molding method. Also, because the prism lenses of the conventional prism sheet is formed by solidifying the melted ultraviolet-cured transparent resin, in use, the prism lenses are easily damaged or scratched due to their poor rigidity and mechanical strength. Compared with the conventional prism sheet, the prism sheet 20 of the present invention has a better rigidity and mechanical strength. Therefore, the present prism sheet is not easily to be damaged or scratched when in use.

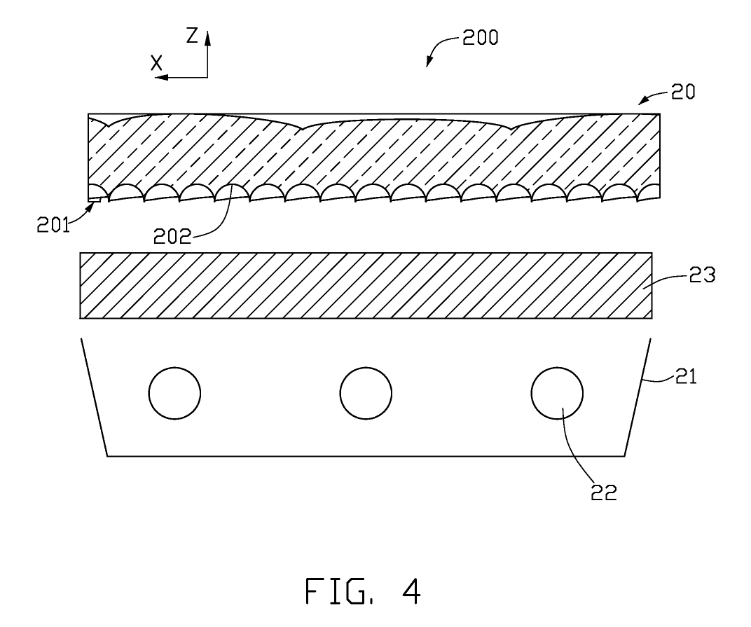

Referring to FIG. 4, a backlight module 200 in accordance with a second preferred embodiment of the present invention is shown. The backlight module 200 includes the prism sheet 20, a housing 21, a plurality of lamps 22, and a light diffusion plate 23. The lamps 22 are regularly aligned above a base of the housing 21. The light diffusion plate 23 and the prism sheet 20 are stacked on the top of the housing 21 in that order. The prism sheet 20 is stacked on the light diffusion plate 21 in a way such that the first surface 201 is adjacent to the light diffusion plate 21, and the second surface 203 faces away from the light diffusion plate 21.

The lamps 22 can be point light sources such as light emitting diodes, or linear light sources such as cold cathode fluorescent lamps. The housing 23 is made of metal or plastic materials with a high reflectivity rate. Alternatively, an interior of the housing 23 is preferably deposited with a high reflectivity coating for improving the light reflectivity rate of the housing 23. In this embodiment, the lamps 22 are cold cathode fluorescent lamps. The housing 23 is made of high reflective metal.

In the prism sheet 20, the micro-depressions 202 are configured for enabling the first surface 201 to converge incident light from the lamps 22 to a certain extent (hereafter first light convergence). The micro-protrusions 204 are configured for enabling the second surface 203 to converge light emitting the second surface 203 (hereafter second light convergence). In the backlight module 200, when light enters the prism sheet 20 via the first surface 201, the light undergoes the first light convergence at the first surface 201. Then the light further undergoes a second light convergence at the second 202 before exiting the prism sheet 20. Thus, a brightness of the backlight module 200 is increased. In addition, because the arrangement of the curved, elongated micro-depressions 202 and micro-protrusions 204 are not aligned with the LCD pixels, light or dark bands produced by diffraction between the prism sheet 20 with the pixel pitch of LCD panel can be decreased or even eliminated.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. A prism sheet comprising:
a transparent main body having:
a first surface,
a second surface opposite to the first surface,
a plurality of elongated, curved micro-depressions formed in the first surface, and
a plurality of elongated, curved micro-protrusions protruding from the second surface,
wherein the micro-depressions extend along first arcs having a same curvature, and the micro-protrusions extend along second arcs having a same curvature.

2. The prism sheet according to claim 1, wherein a line connecting centers of the first arcs is perpendicular to a line connecting centers of the second arcs.

3. The prism sheet according to claim 1, wherein a line connecting centers of the first arcs is oblique to a line connecting centers of the second arcs.

4. The prism sheet according to claim 1, wherein each of the micro-depressions has a semicircle cross-section taken along a line connecting centers of the first arcs.

5. The prism sheet according to claim 1, wherein each of the micro-protrusions has a semicircle cross-section taken along a line connecting centers of the second arcs.

6. The prism sheet according to claim 1, wherein a thickness of the prism sheet is in a range from about 0.5 millimeters to about 3 millimeters.

7. The prism sheet according to claim 1, wherein a pitch between adjacent micro-depressions along a line connecting the centers of first arcs is in the range from about 0.025 millimeters to about 1.5 millimeters.

8. The prism sheet according to claim 1, wherein the prism sheet is made of transparent material selected from the group consisting of polycarbonate, polymethyl methacrylate, polystyrene, copolymer of methylmethacrylate and styrene, and any combination thereof.

9. A backlight module comprising:
a plurality of lamps;
a light diffusion plate disposed above the lamps; and
a prism sheet disposed on the light diffusion plate, the prism sheet includes a transparent main body having:
a first surface,
a second surface opposite to the first surface,
a plurality of elongated, curved micro-depressions formed in the first surface, and
a plurality of elongated, curved micro-protrusions protruding from the second surface,
wherein the micro-depressions extend along first arcs having a same curvature, and the micro-protrusions extend along second arcs having a same curvature.

10. The backlight module according to claim 9, wherein a line connecting centers of the first arcs perpendiculars to a line connecting centers of the second arcs.

11. The backlight module according to claim 9, wherein a line connecting centers of the first arcs is oblique with a line connecting centers of the second arcs.

12. The backlight module according to claim 9, wherein each of the micro-depressions has a semicircle cross-section taken along a line connecting centers of the first arcs.

13. The backlight module according to claim 9, wherein each of the micro-protrusions has a semicircle cross-section taken along a line connecting centers of the second arcs.

14. The backlight module according to claim 9, wherein a thickness of the prism sheet is in a range from about 0.5 millimeters to about 3 millimeters.

15. The backlight module according to claim 9, wherein a pitch between adjacent micro-depressions along a line connecting the centers of first arcs is in the range from about 0.025 millimeters to about 1.5 millimeters.

16. The backlight module according to claim 9, further comprising a housing, the lamps are regularly aligned above a base of the housing.

17. The backlight module according to claim 9, wherein the prism sheet is stacked on the light diffusion plate in a way such that the first surface is adjacent to the light diffusion plate, and the second surface faces away from the light diffusion plate.
